(19) United States
(12) Patent Application Publication
(10) Pub. No.: US 2014/0290765 A1
(43) Pub. Date: Oct. 2, 2014

(54) GAS RECYCLING SYSTEM FOR A CONTROLLED ATMOSPHERE UNIT OPERATION

(71) Applicant: H2 PUMP LLC, Latham, NY (US)

(72) Inventors: Robert S. Hirsch, Troy, NY (US); Jonathan Kinsey, Malta, NY (US); Gary Crewell, Altamont, NY (US); Glenn A. Eisman, Niskayuna, NY (US)

(73) Assignee: H2 PUMP LLC, Latham, NY (US)

(21) Appl. No.: 13/855,219

(22) Filed: Apr. 2, 2013

(51) Int. Cl. F27D 17/00

(52) U.S. Cl. CPC F27D 17/001
USPC 137/563

(57) ABSTRACT

A gas recycling system for a controlled atmosphere furnace includes a controlled atmosphere furnace having a product entry, a product exit, a process gas inlet adjacent said product exit, and a spent gas outlet adjacent said product entry. A spent gas recycler is operationally connected to the spent gas outlet. The recycler produces a recycled process gas stream and a waste gas stream. The recycled process gas stream is returned to the controlled atmosphere furnace. The waste gas stream is returned to the controlled atmosphere furnace at a point downstream from the spent gas outlet.

### FIELD OF THE INVENTION

The invention is directed to a gas recycling system for a controlled atmosphere unit operation (e.g., a controlled atmosphere furnace).

### BACKGROUND OF THE INVENTION

A controlled atmosphere unit operation refers to any process step requiring a controlled atmosphere (a controlled atmosphere is not the ambient atmosphere). For example, the controlled atmosphere unit operation may be a controlled atmosphere furnace or semiconductor manufacturing equipment. In a controlled atmosphere furnace, a component is heated or processed in the controlled atmosphere. To facilitate the explanation of the invention, the inventive gas recycling system will be discussed in relationship to a controlled atmosphere furnace, but the invention is not so limited and the gas recycling system may be used in conjunction with any operation (process step) that requires a controlled atmosphere.

Controlled atmosphere furnaces may be generally categorized as closed furnaces or open furnaces. In the closed furnace, the components are generally sealed within the furnace and there are no openings to the ambient atmosphere; these closed furnaces would be used in batch operations. The pressure within these closed furnaces may be above, equal to, or below the ambient pressure. Some closed furnaces (referred to as semi-closed furnaces) may have small openings to allow the entry and exit of components, and thus may be used in continuous operations. Generally, these semi-closed furnaces are operated at pressures slightly above ambient pressure. An example of a semi-closed furnace is the foil furnace; the foil furnace may be used to heat treat, under a controlled atmosphere, a sheet of material (e.g., a roll of sheet steel).

In the open furnace, the components are driven through the furnace, and therefore, it has at least two openings, one for the components to enter the furnace and another for the components to exit the furnace; these open furnaces would be used in continuous operations. The pressure within the open furnace is generally equal to, or slightly greater than, the ambient pressure. In general, the openings may be closed by the use of a curtain. In this instance, closed refers to a barrier to prevent ingress of the ambient atmosphere. A flame curtain is an example. When hydrogen is used to form, all or a part of, the controlled atmosphere; as the hydrogen escapes from the furnace, it combusts with the oxygen in the ambient atmosphere to from the flame curtain. Examples of the open furnace include: pusher furnaces, humpback furnaces, flatback furnaces, and the like.

In the open furnace, it has been believed that recycling the controlled atmosphere is impossible. In the open furnace, the furnace is open at two ends, as described above. To maintain the controlled atmosphere within the furnace, the furnace cavity is flooded with the process gas. By flooded, it is meant that the process gas is pumped into the cavity so that it overflows the cavity and exits at the openings. In so doing, the process gas prevents the ingress of ambient atmosphere. By flooding the cavity, a steady state condition with respect to the gaseous atmosphere is formed within the cavity of the furnace. If any gas is withdrawn from the cavity, then the steady state within the cavity is upset and the ambient atmosphere would rush in and thereby destroy the controlled atmosphere of the furnace. Therefore, gas is not withdrawn from the furnace cavity to avoid disruption of the steady state gaseous atmosphere within the furnace cavity.

Recycling the spent gas from the controlled atmosphere unit operation would be a cost savings to the operators of controlled atmosphere unit operations. These gases are obtained at a cost (either purchased from a vendor or made on site via an investment in capital equipment). One important gas is hydrogen.

Accordingly, there is a need for a system to recycle the spent gas from the controlled atmosphere unit operation.

### SUMMARY OF THE INVENTION

A gas recycling system for a controlled atmosphere unit operation includes a controlled atmosphere unit operation having a product entry, a product exit, a process gas inlet adjacent said product exit, and a spent gas outlet adjacent said product entry. A spent gas recycler is operationally connected to the spent gas outlet. The recycler produces a recycled gas stream and a waste gas stream. The recycled gas stream is returned to the controlled atmosphere unit operation. The waste gas stream is returned to the controlled atmosphere furnace at a point downstream from the spent gas outlet.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of the gas recycling system for a controlled atmosphere unit operation.

FIG. 2 is a schematic illustration of an embodiment of the recycler.

FIG. 3 is a schematic illustration of another embodiment of the gas recycling system.

### DESCRIPTION OF THE INVENTION

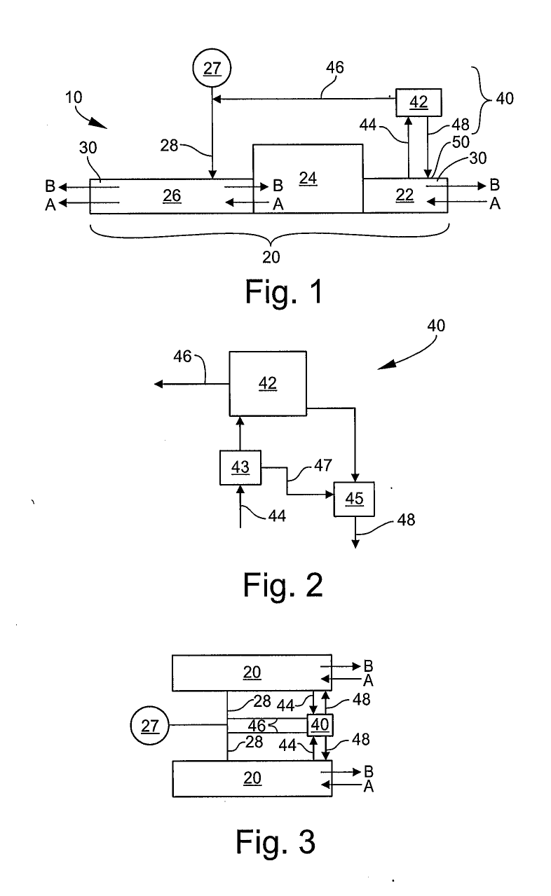

Referring to the drawings, where like elements have like numerals, shown in FIG. 1 is a recycling system for a controlled atmosphere unit operation. The recycle system 10 includes a controlled atmosphere unit operation 20 and a spent gas recycler 40. Hereinafter, unit operation 20 will be referred to as a furnace, it being understood that the recycle system may used with any controlled atmosphere, particularly a controlled atmosphere containing hydrogen gas, unit operation and any unit operation may replace the furnace.

The furnace 20 may include, in one embodiment, a pre-heating region (or muffle) 22, a hot box (or furnace cavity) 24, and a cooling region 26, or any combination or sub combination thereof. The terminal ends (i.e., the ends of the pre-heating region and the cooling region) away from (or distal to) the hot box are open to the ambient atmosphere to allow the ingress and egress of product. The flow of product through the furnace 20 is indicated by arrows A. Process gas is introduced into furnace 20 via process gas inlet 28. The process gas inlet 28 is coupled to a supply 27 of process gas. The flow of process gas through furnace 20 is indicated by arrows B (note: typically, the process gas will flow countercurrent to the product through the hot box 24 and pre-heating region 22 and will flow concurrently with the product through most of the cooling region 26). In one embodiment, the process gas may comprise hydrogen. Hydrogen may comprise all, or a portion, of the process gas.

The furnace 20 may further include curtains 30 adjacent the terminal ends of the pre-heating 22 and cooling regions 26. These curtains may be physical (e.g., temperature resistant fabric) or a gas stream (i.e., inert gas (e.g., nitrogen, argon)) or a flame (e.g., formed of combustible gas (e.g., hydrogen, methane, propane, or the like) with oxygen (typically, sourced from the ambient atmosphere or supplied from another source)) or a combination thereof.

The spent gas recycler 40 includes, in one embodiment, recycler 42, a spent gas outlet 44, a recycled gas stream 46, and a waste gas stream 48.

The recycler 42 (discussed in greater detail below) is in fluid communication with furnace 20 via spent gas outlet 44. The process gas, introduced in the cooling region 26 via process gas inlet 28, flows through furnace 20 as indicated by arrows B. As the process gas traverses the furnace 20 (countercurrent to the product flow A), the process gas becomes spent (i.e., dirty, consumed, partially reacted, contaminated, or the like). A portion, or all, of this spent gas is withdrawn from furnace 20 via spent gas outlet 44 and received by the recycler 42. In one embodiment, the volume of spent gas withdrawn from the furnace 20 is controlled so that the flame curtain is not fully extinguished. In another embodiment, i.e., the semi-closed unit operation, the volume of spent gas withdrawn may be controlled so that the unit operation's pressure is not disturbed significantly. Spent gas not withdrawn to the recycler 42 may exit via any opening in the furnace 20. In one embodiment, spent gas outlet 44 is positioned adjacent to the furnace 20 opening where product enters the furnace 20. In another embodiment, outlet 44 may be positioned in the muffle 22 between the hot box 24 and the product entry to the muffle 22.

The spent gas is delivered to the recycler 42 where it is recycled forming a recycled gas stream 46 and a waste gas stream 48. The recycled gas from the recycler 42 will have the chemical properties of the virgin process gas introduced via inlet 28 or a portion of the virgin gas introduced via inlet 28. The waste gas from the recycler 42 may contain a portion of the process gas introduced via inlet 28.

The recycled gas in stream 46 may be returned to furnace 20 via, for example, process gas inlet 28. The waste gas stream 48 may be returned to the furnace 20 via waste gas inlet 50, where the waste gas, at least a portion, may be used to fuel the flame curtain. In one embodiment, waste gas inlet 50 is located downstream, in relation to the process gas flow B, from spent gas outlet 44. When the spent gas is intended to fuel, at least partially, the flame curtain, the waste gas may be introduced through a plurality of ports in furnace 20 to ensure the uniform (or homogenous) mixing of the waste gas into the controlled atmosphere of the furnace. In so doing, uniformity of the flame curtain may be maintained. Since, recycler 42 returns the spent gas stream to the furnace as the recycled gas stream and the waste gas stream, in the ideal case, the steady state balance of the process gas forming the controlled atmosphere within the furnace is maintained, thereby preventing the ingress of ambient atmosphere through the open ends of the furnace. However, in actual operation, it may be necessary to supplement the recycled gas and/or waste gas to maintain the steady state balance.

The recycler 42 may be any device or apparatus capable of recycling the process gas from the spent gas. Such devices/apparatus include, but are not limited to, electrochemical pumps, compressors, pumps, blowers, and combinations thereof. In one embodiment (where the process gas is rich in hydrogen), the recycler 42 may utilize an electrochemical hydrogen pump. Electrochemical hydrogen pumps are known, for example see: US2009/0176180; US2010/0243475; US2004/0028960; US2003/0196893; US2007/0193885; US2007/0227900; US2007/0246373; US2007/0246363; US2007/0246374; and US2008/0121532, and U.S. Ser. No. 13/653,491 filed Oct. 17, 2012, each of which is incorporated herein by reference. For example, in an electrochemical cell utilizing a proton exchange membrane, the membrane is sandwiched between a first electrode (anode) and a second electrode (cathode), as defined in the hydrogen pumping mode. The spent gas (containing hydrogen) is supplied to the first electrode. An electric potential is placed between the first and the second electrodes. The first electrode's potential with respect to ground (or zero) is greater than the second electrode's potential with respect to ground. Each hydrogen molecule reacted at the first electrode produces two protons which are driven through the membrane by the applied electric field to the second electrode of the cell, where they are rejoined by two electrons to reform the hydrogen molecule (sometimes referred to as ‘evolving hydrogen’ at the electrode). In one embodiment, the recycler is used to recycle hydrogen from the spent gas.

FIG. 2 illustrates a further embodiment of the spent gas recycler 40. In this embodiment, spent gas recycler 40 further includes a spent gas conditioner 43 and a waste gas conditioner 45. In operation, spent gas from 44 is delivered to conditioner 43 where it is conditioned (e.g., cooled and/or dried, e.g., removal of moisture, and/or partly purified, e.g., removal of particulate to facilitate recycling) prior to entry into recycler 42. A portion of the spent gas (rich in process gas) may be diverted 47 to the waste gas stream 44 for re-introduction into furnace 20 via, for example, waste gas stream 48. The diversion of the spent gas (rich in process gas) may be advantageous, if, for example, the process gas is combustible, then it can be used to fuel a flame curtain. After the spent gas is recycled, the waste gas stream of the recycler may be directed to waste gas conditioner 45. In the conditioner 45, the waste gas is conditioned (e.g., dried and/or heated to, at least approximate the conditions within the furnace) for reentry into furnace 20, e.g., to support or partially support the flame curtain requirements.

FIG. 3 illustrates another embodiment of the recycling system where one recycler 40 is used with multiple unit operations 20. In this embodiment, one recycler 40 takes spent gas from two or more unit operations 20. After the spent gas is recycled, as described above, into the recycled stream and the waste stream, those streams are returned to the one or more unit operations, as described above, so that the steady state balance of the controlled atmosphere within the unit operation 20 is not lost. As necessary and described above, supplement gas may be used to facilitate the balance in each operation 20. In one embodiment, the recycle stream may be returned to the process gas supply 27 before return to the unit operations 20.

To insure the integrity of the controlled atmosphere within the unit operation, a number of oxygen sensors (not shown) may be placed within the unit operation 20 to sense if ambient atmosphere enters the unit operation 20. Additionally, a number of flame sensors (not shown) may be used to insure that flame curtains are maintained.

### EXAMPLES

The present invention will be further illustrated by way of the following examples:

### Example 1

### Control

In a flatback furnace, the input muffle opening and the product muffle exit opening are entirely open and exposed to the ambient atmosphere. Hydrogen is fed into the gas inlet port located downstream of the hot zone (in the product exit zone) and flows counter-current to the product flow through the hot zone. The hydrogen flows into the hot zone and then into the product introduction muffle where it then passes out of the furnace. Concurrently, a percentage of the hydrogen flows to the product muffle exit. At the part entry muffle, the parts enter through a flame curtain. The flame curtain thereby prevents oxygen from entering the furnace. At the part exit muffle, the parts exit through a physical curtain, at which point, the spent hydrogen is directed out through the top of the muffle where it is ignited to create a flame.

In Example 1, the control, the furnace is being fed process gas at approximately 700 standard cubic feet per hour (scfh). In this example, the hydrogen is completely combusted at the openings.

### Example 2

### Invention

In this example, the furnace is the same as the one described in Example 1. Hydrogen is extracted by the recycler from a waste port located downstream of the hot zone of the furnace (input muffle zone) with respect to the gas flow. The furnace is fed 700 scfh of virgin hydrogen. With the recycler in place, approximately 400 scfh are extracted via the waste port and fed to the recycling unit. In operation, 350 scfh of hydrogen are pumped through the recycler, then pressurized and dried. 50 scfh of the initial 400 scfh fed to the recycler is considered “waste” gas and can be comprised of unrecycled hydrogen, water, and nitrogen. The recycler product gas is ultimately fed back to the hot zone, whereas the waste gas of the recycler is fed back to the opening of the part entry muffle. It is observed that the flame curtain is still present at the part entry muffle of the furnace. In this example, the flame curtain is partly generated by the hydrogen in the recycler's waste stream hydrogen reacting with oxygen from the air at the muffle opening. In this example, a small quantity of nitrogen is used in combination with the hydrogen. The gas to be combusted at the muffle ends comes from the recycler waste stream, as well as, some unrecycled hydrogen emanating from the hot zone.

In this example the balance of the gaseous atmosphere in the furnace is not significantly changed or disturbed. In this example, the recycler product gas has a dew point of ˜−70° C. In this example, the recycler waste stream exhibits a dew point of room temperature, or about 7% water.

### Example 3

### Invention

The furnace of Example 1, the recycler of Example 2, an inert gas is supplementing the waste gas stream of the recycler. The curtain is an inert gas which prevents oxygen from the air from entering the muffles of the furnace.

In this example, it is deemed unnecessary to utilize a “flame” curtain. In its place, inert gas is introduced to the furnace and prevents the air from entering the muffles. 700 scfh of virgin hydrogen is fed to the furnace as in Examples 1 and 2. Spent furnace hydrogen at a rate of 400 scfh is extracted from the furnace as in Example 2 and contains a mixture of ˜60% hydrogen, 40% nitrogen. In this example additional nitrogen is fed to supplement the existing nitrogen curtains at the opening of the muffles, while approximately 350 scfh of recycler product hydrogen is fed back to the furnace with a dew point of ˜−70° C., and pressurized. Approximately 200 scfh of nitrogen is added to maintain the furnace atmosphere balance.

The present invention may be embodied in other forms without departing from the spirit and the essential attributes thereof, and, accordingly, reference should be made to the appended claims, rather than to the foregoing specification, as indicated the scope of the invention.

We claim:

1. A gas recycling system for a controlled atmosphere unit operation comprising:
a controlled atmosphere unit operation having a product entry, a product exit, a process gas inlet adjacent said product exit, and a spent gas outlet adjacent said product entry;
a spent gas recycler operationally connected to said spent gas outlet, said recycler producing a recycled gas stream and a waste gas stream;
wherein said recycled gas stream being returned to said controlled atmosphere unit operation and said waste gas stream being returned to said controlled atmosphere unit operation at a point downstream from said spent gas outlet.

2. The gas recycling system of claim 1 wherein said spent gas recycler being an electrochemical hydrogen pump.

3. The gas recycling system of claim 1 wherein said controlled atmosphere unit operation being an open controlled atmosphere furnace.

4. The gas recycling system of claim 3 wherein said open controlled atmosphere furnace being selected from the group consisting of: pusher furnaces, humpback furnaces, and flatback furnaces.

5. The gas recycling system of claim 3 wherein said product exit of said controlled atmosphere furnace further comprises a cooling region and said process gas inlet being located in said cooling region.

6. The gas recycling system of claim 5 wherein said cooling region including a curtain for preventing ingress of ambient atmosphere.

7. The gas recycling system of claim 3 wherein said product entry of said controlled atmosphere furnace comprise a pre-heating region and said spent gas outlet being proximate said controlled atmosphere furnace and said waste gas stream being distal said controlled atmosphere furnace.

8. The gas recycling system of claim 7 wherein said pre-heating region includes a curtain for preventing ingress of ambient atmosphere.

9. The gas recycling system of claim 8 wherein said curtain in said pre-heating region being a gas curtain formed from the gases selected from the group consisting of: said waste gas stream, said recycled process gas stream, a supplement gas, and combinations thereof.

10. The gas recycling system of claim 8 wherein said supplement gas being selected from the group consisting of: an inert gas, a non-combustible gas, a combustible gas, and a combination thereof.

11. The gas recycling system of claim 1 wherein said spent gas recycler further comprises a spent gas conditioner operationally connected between said unit operation and said spent gas recycler.

12. The gas recycling system of claim 11 wherein said spent gas conditioner being adapted to perform one or more of the following: cool said spent gas, dry said spent gas, and/or purify said spent gas.

13. The gas recycling system of claim 1 wherein said spent gas recycler further comprises a waste gas conditioner operationally connected between said spent gas recycler and said unit operation.

14. The gas recycling system of claim 13 wherein said waste gas conditioner being adapted to perform one or more of the following: heat said spent gas, dry said spent gas, and/or purify said spent gas.

15. The gas recycling system of claim 1 wherein said spent gas recycler being operationally connected to two or more unit operations.

16. The gas recycling system of claim 15 wherein said gas recycler receiving spent gas from two or more unit operations and returning a recycled gas to a process gas supply.

17. The gas recycling system of claim 14 wherein said gas recycler returns a waste gas to one or more of the unit operations.
